(19) United States
(12) Patent Application Publication
(10) Pub. No.: US 2022/0019685 A1
(43) Pub. Date: Jan. 20, 2022

(54) MANAGING ENTERPRISE DATA RETENTION

(71) Applicant: International Business Machines Corporation, Armonk, NY (US)

(72) Inventors: Mauro Marzorati, Lutz, FL (US); Zachary A. Silverstein, Jacksonville, FL (US); Cesar Augusto Rodriguez Bravo, Alajuela (CR); Craig M. Trim, Ventura, CA (US)

(21) Appl. No.: 16/930,266

(22) Filed: Jul. 15, 2020

(51) Int. Cl. G06F 21/62; G06F 11/30

(52) U.S. Cl. CPC G06F 21/6227; G06F 2201/835; G06F 11/3034; G06F 21/6254

(57) ABSTRACT

Aspects of the present invention disclose a method, computer program product, and system for managing data based on updates to data management policies. The method includes one or more processors monitoring data sources for updates to data management policies that apply to an organization. In response to identifying an update to a data management policy that applies to the organization, the method further includes one or more processors generating a data management rule based on the update to the data management policy. The data management rule includes a defined action to take on data records that correspond to a defined characteristic. The method further includes one or more processors identifying a first set of data records that include the defined characteristic of the rule. The method further includes one or more processors performing the defined action of the rule on the first set of data records.

### BACKGROUND OF THE INVENTION

The present invention relates generally to the field of data management, and more particularly to managing data retention based on data policy updates.

A database is an organized collection of data, generally stored and accessed electronically from a computer system. A database management system (DBMS) is the software that interacts with end users, applications, and the database itself to define, manipulate, retrieve and manage data in a database. The DBMS software additionally encompasses the core facilities provided to administer the database. The combination of the database, the database management system, and the associated applications can be referred to as a “database system.”

A DBMS (or similar application/service) can operate to manage the data in various databases for an enterprise (i.e., as an aspect of Enterprise Data Management (EDM)). The stored data can be managed (e.g., archived, deleted, modified, etc.) according to a plurality of data policies that are employed by the enterprise. For example, an enterprise can manage data utilizing customized data policies defined by the enterprise, data policies defined by external entities (e.g., government policies, regulatory policies, contract-specific policies, etc.), and a combination thereof. An example data management policy is the “right to be forgotten” policy. The right to be forgotten is the right to have information about a person (e.g., negative information, private information etc.) to be removed from Internet searches and other directories under some circumstances.

A content management system (CMS) is a software application that can be used to manage the creation and modification of digital content. CMSs are typically used for enterprise content management (ECM) and web content management (WCM). ECM typically supports multiple users in a collaborative environment by integrating document management, digital asset management, and record retention. Alternatively, WCM is the collaborative authoring for websites and may include text and embed graphics, photos, video, audio, maps and program code that display content and interact with the user. ECM typically includes a WCM function.

### SUMMARY

Aspects of the present invention disclose a method, computer program product, and system for managing data based on updates to data management policies. The method includes one or more processors monitoring data sources for updates to data management policies that apply to an organization. In response to identifying an update to a data management policy that applies to the organization, the method further includes one or more processors generating a data management rule based on the update to the data management policy. The data management rule includes a defined action to take on data records that correspond to a defined characteristic. The method further includes one or more processors identifying a first set of data records that include the defined characteristic of the data management rule. The method further includes one or more processors performing the defined action of the data management rule on the first set of data records.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for managing data based on updates to data management policies, in accordance with embodiments of the present invention.

FIG. 3 depicts a block diagram of components of a computing system representative of the computing device and data management system of FIG. 1, in accordance with an embodiment of the present invention.

### DETAILED DESCRIPTION

Embodiments of the present invention allow for a system and method to automatically implement data management policies on stored data in an enterprise environment. For example, embodiments of the present invention facilitate automatic implementation of a “right to be forgotten” data policy for a content management system (CMS). Accordingly, embodiments of the present invention can operate to implement a mechanism to execute a plurality of data management actions based on a right to be forgotten data policy (e.g., delete content, hide content, anonymize content, etc.).

Some embodiments of the present invention recognize that the amount of information about users is growing substantially. Managing the growing amount of data is increasing in difficulty, as each different platform, application, and interaction can be subject to different data authorizations and data management policies. Embodiments of the present invention also recognize that new data management policies are constantly being created and updated, such as the “right to be forgotten” data policy. Accordingly, embodiments of the present invention recognize the importance of managing enterprise data in accordance with an updating corpus of data management requirements and policies, from a plurality of sources. In addition, embodiments of the present invention recognize the value in providing an automated solution for analyzing updated and new data management policies, and then implementing data management automatically in an enterprise environment, according to the data policy requirements (e.g., data retention right to be forgotten, etc.).

Embodiments of the present invention can operate to provide a system and method that manages and updates a database of data management policies, received and retrieved from a plurality of sources (e.g., internal and external to an enterprise). Further, embodiments of the present invention can provide a monitoring engine that correlates data management policies with data in data repositories in an enterprise (e.g., in a CMS) to automatically delete and/or modify data records based on the data management policies. In addition, embodiments of the present invention can monitor existing data management policies for updates, and automatically take relevant actions on data records based on the updated policies (e.g., delete records, anonymize data, etc.).

In additional aspects, embodiments of the present invention can schedule future data management operations, based on identifying updates to data policy information. For example, in response to determining that a new (or updated) data management policy defines an expiration date for a set (or type) of data records, embodiments of the present invention can schedule future data management actions, corresponding to the policy updates. In another aspect, embodiments of the present invention can communicate results of the performed or scheduled data management actions to one or more users, based on a corresponding policy (e.g., to one or more individuals that are associated with the impacted records, administrative users, etc.).

Implementation of embodiments of the invention may take a variety of forms, and exemplary implementation details are discussed subsequently with reference to the Figures.

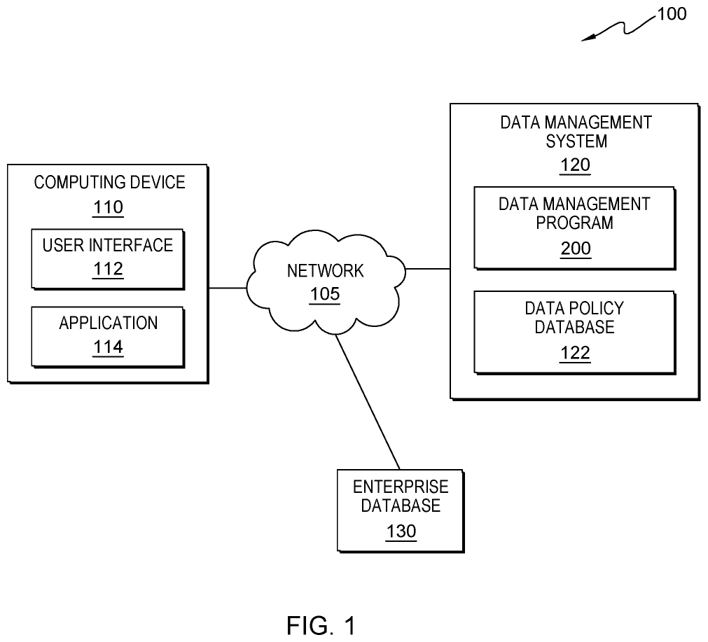

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes computing device 110, data management system 120, and enterprise database, all interconnected over network 105. In an example embodiment, data management system 120 is representative of a computing device (e.g., one or more management servers) that provides data management services to one or more organizations, such as an organization associated with enterprise database 130. In other embodiments, data processing environment 100 can include additional instances of computing devices (not shown) that can interface with data management system 120, in accordance with various embodiments of the present invention.

Network 105 can be, for example, a local area network (LAN), a telecommunications network, a wide area network (WAN), such as the Internet, or any combination of the three, and include wired, wireless, or fiber optic connections. In general, network 105 can be any combination of connections and protocols that will support communications between computing device 110, data management system 120, and enterprise database 130, in accordance with embodiments of the present invention. In various embodiments, network 105 facilitates communication among a plurality of networked computing devices (e.g., computing device 110, data management system 120, and other devices not shown), corresponding users (e.g., users of computing device 110 or data management system 120, etc.), and corresponding management services (e.g., data management system 120).

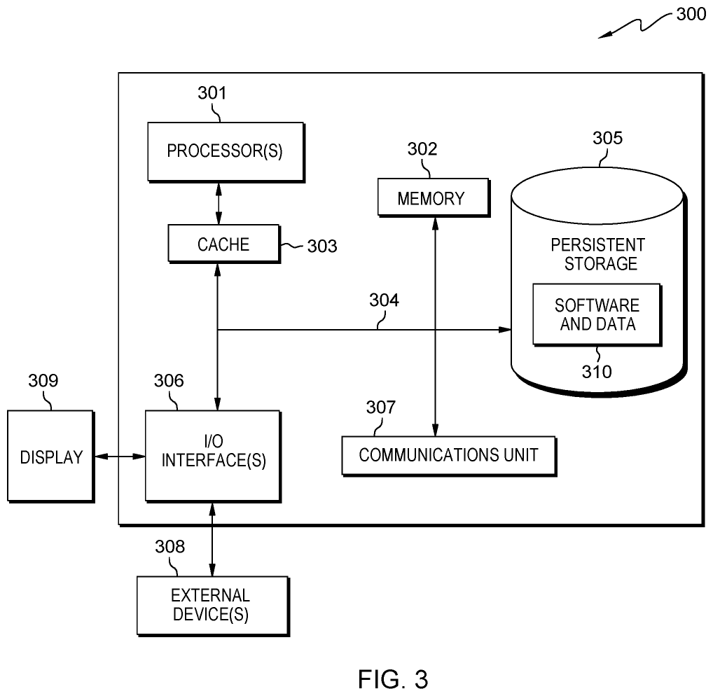

In various embodiments of the present invention, computing device 110 may be a workstation, personal computer, personal digital assistant, mobile phone, or any other device capable of executing computer readable program instructions, in accordance with embodiments of the present invention. In general, computing device 110 is representative of any electronic device or combination of electronic devices capable of executing computer readable program instructions. Computing device 110 may include components as depicted and described in further detail with respect to FIG. 3, in accordance with embodiments of the present invention.

In an example embodiment, computing device 110 is a personal workstation or mobile device associated with (e.g., registered to) a user that is associated with data records that are stored in enterprise database 130. In one example, computing device 110 is associated with an employee of an organization that has data records stored in enterprise database 130. In another example, computing device 110 is associated with a user that receives notifications indication data management actions by data management system 120 on enterprise database 130 (e.g., a manager, an administrator, an employee, etc.).

Computing device 110 includes user interface 112 and application 114. User interface 112 is a program that provides an interface between a user of computing device 110 and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API).

Application 114 can be representative of one or more applications (e.g., an application suite) that operate on computing device 110. In various example embodiments, application 114 can be an application that a user of computing device 110 utilizes to send and/or receive data from data management system. In another example embodiment, application 114 can be an application associated with providing data to, and receiving information from, enterprise database 130. For example, application 114 is a web browser that the user of computing device 110 can access and utilize. In another example, application 114 is an enterprise-specific application, associated with enterprise database 130 and/or the corresponding organization.

In example embodiments, data management system 120 can be a desktop computer, a computer server, or any other computer systems, known in the art. In certain embodiments, data management system 120 represents computer systems utilizing clustered computers and components (e.g., database server computers, application server computers, etc.) that act as a single pool of seamless resources when accessed by elements of data processing environment 100 (e.g., computing device 110, enterprise database 130, and other devices not shown). In general, data management system 120 is representative of any electronic device or combination of electronic devices capable of executing computer readable program instructions. Data management system 120 may include components as depicted and described in further detail with respect to FIG. 3, in accordance with embodiments of the present invention.

Data management system 120 includes data policy database 122 and data management program 200. In various embodiments of the present invention, data management system 120 operates as a computing system that provides data management services to one or more organizations. For example, data management system 120 operates to perform data management services for an organization that includes enterprise database 130. In one embodiment, data management system 120 can analyze existing and new/updated data management policies to determine actions for managing data in enterprise database 130. For example, data management system 120 includes, or has access to (over network 105), natural language processing (NLP) functionality. Accordingly, data management system 120 can analyze data management policies utilizing NLP to identify updated information and generate data management rules and perform corresponding data management actions, in accordance with various embodiments of the present invention.

In additional embodiments, data management system 120 (utilizing data management program 200) can operate to automatically schedule and execute data management actions on enterprise database 130. For example, data management system 120 can periodically execute data management program 200 (e.g., once a day, once an hour, etc.). In another example, data management system 120 can execute data management program 200 in response to identifying, or receiving an indication, that new data is added to enterprise database 130.

In example embodiments, data management program 200 manages data based on updates to data management policies, in accordance with embodiments of the present invention. Data management program 200 can provide advantages through an automated process to manage data for an organization, taking into account constantly updating data management policies. In addition, data management system 120 can utilize data management program 200 and NLP analysis functionality to create and maintain an up-to-date database of data management policies that apply to an organization (i.e., data policy database 122).

In an example scenario, “Organization A” is a software company that collects user and customer data (stored in enterprise database 130) that is subject to data management policies, such as a “right to be forgotten” data management policy. Data management program 200 can ingest organization-specific policies for Organization A, as well as any relevant government regulations and policies, and analyze the policies (e.g., utilizing NLP). In this example scenario, data management program 200 can derive a plurality of data management rules that are applicable for data content in enterprise database 130. In a further aspect of the example scenario, data management system 120 identifies a new data management regulation that has been issued that is relevant to Organization A. Data management program 200 can derive new data management rules that correspond and adhere to the new data management regulation. Then data management program 200 can execute data management actions, and schedule future data management actions, according to the new data management regulation (and take into account existing data management policies in data policy database 122).

Data policy database 122 can be implemented with any type of storage device, for example, persistent storage 305, which is capable of storing data that may be accessed and utilized by data management system 120, such as a database server, a hard disk drive, or a flash memory. In other embodiments, data policy database 122 can represent multiple storage devices and collections of data within data management system 120. A database is an organized collection of data, generally stored and accessed electronically from a computer system. In various embodiments, data management system 120 can utilize data policy database 122 to store all data management policies (e.g., for data retention, modifying data, data deletion, etc.) that are relevant to data of an organization (e.g., data in enterprise database 130. In various embodiments, data management policies define the management and governance of data within a system, such as when to delete or modify data (e.g., right to be forgotten policy, etc.), data notifications policies, etc.

In example embodiments, data policy database 122 stores organization-specific policies, as well as any relevant government regulations and policies (e.g., contract specific policies, location specific policies, etc.) for the organization. In another embodiment, data policy database 122 can store an aggregated data policy for an organization. For example, data management system 120 can aggregate all data policies that are relevant to an organization, and then generate an aggregated data policy that includes the most up-to-date and relevant data management policies to the organization. In an additional embodiment, data policy database 122 can include information indicating a hierarchy between data management policies. For example, a government regulation policy can be associated with a higher priority than an organizational preference, etc.

In various embodiment, data management system 120 can continuously ingest new data management policies, as the policies are identified and/or made available. For example, data management system 120 can monitor multiple data sources (not shown) for additions/updates to data management policies to analyze and utilize to update data policy database 122 (e.g., analyze utilizing NLP and feature extraction techniques). In additional examples, data management system 120 can receives new and/or updated data management policies from a plurality of sources, to analyze and utilize to update data policy database 122. In additional embodiments, data policy database 122 can store data management rules for an organization. For example, data policy database 122 stores data management rules and scheduled data management operations that data management program 200 derives for managing data in enterprise database 130, in accordance with various embodiments of the present invention.

Enterprise database 130 is representative of one or more data storage collections that correspond to a particular enterprise/organization. A database is an organized collection of data, generally stored and accessed electronically from a computer system. In various embodiments, enterprise database 130 is a collection of one or more databases that data management system 120 manages (e.g., utilizing data management program 200). In example embodiments, enterprise database 130 stores data records that data management system 120 manages in accordance with data management policies in data policy database 122, in accordance with various embodiments of the present invention.

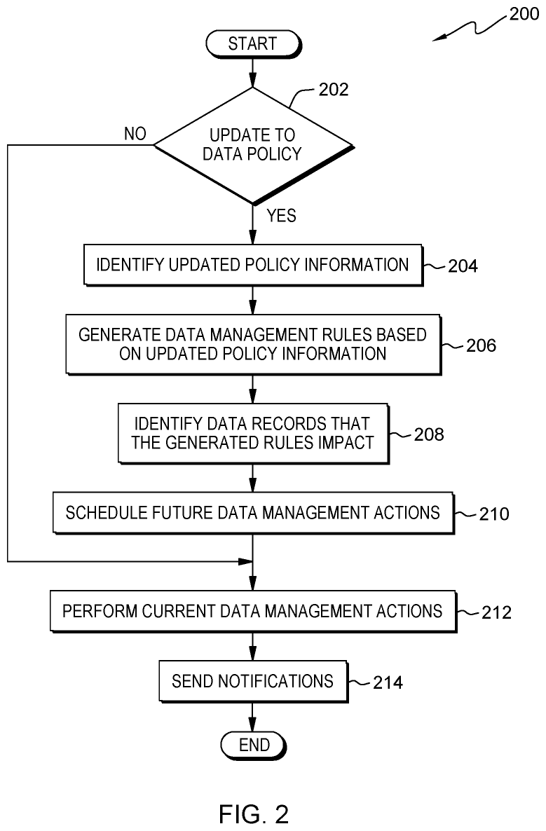

FIG. 2 is a flowchart depicting operational steps of data management program 200, a program for managing data based on updates to data management policies, in accordance with embodiments of the present invention. In one embodiment, data management program 200 initiates in response to receiving and/or identifying a new and/or updated data management policy (e.g., that applies to data in enterprise database 130). In another embodiment, data management program 200 initiates periodically or at defined time intervals (e.g., at scheduled times, etc.). In a further embodiment, data management program 200 can initiate in response to a user request (e.g., initiate in response to receiving a request from a user of computing device 110, or other user associated with an organization). In an additional embodiment, data management program 200 can initiate in response to certain defined actions in an organization (e.g., closing of a case or completion of a contract, at a point in an event management queue, or other organization-defined actions, etc.)

In decision step 202, data management program 200 determines whether a data policy update is available. In one embodiment, data management program 200 determines whether data management system 120 has identified and/or received a new data policy, or an update to an existing data policy, that applies to enterprise database 130. In an example embodiment, data management program 200 determines that data management system 120 has identified an update to an existing data policy that applies to the organization associated with enterprise database 130 (e.g., an update to a data policy in data policy database 122). In another example embodiment, data management program 200 determines that data management system 120 receives a new data policy that is applicable to data records in enterprise database 130. In various embodiments, data management program 200 monitors a plurality of data sources not shown) for additions/updates to data management policies that may be relevant to enterprise database 130.

In a further embodiment, data management program 200 can compare received/identified data policies with existing data policy information in data policy database 122. For example, data management program 200 can parse and analyze information in the received/identified data policies and the contents of data policy database 122 (e.g., utilizing NLP) to classify and identify information in the data policies and data policy database 122. In various embodiments, data management program 200 can compare date information, revision information, priority information, etc., to determine whether a received/identified policy is new and/or updated. For example, data management program 200 can determine that a received data management policy is a new version of a policy in data policy database 122. In another example, data management program 200 can determine that a received/identified policy is a new policy (e.g., issued by a regulatory agency, associated with a new contract, etc.) that applies to the organization associated with enterprise database 130.

In response to determining that a data policy update is not available (decision step 202, NO branch), data management program 200 can perform current data management operations (step 212). In an alternate embodiment, in response to determining that a data policy update is not available (decision step 202, NO branch), data management program 200 can schedule future data management operations (step 210). In other embodiments, data management system 120 (and data management program 200) can operate to continuously schedule data management operations, based on information in data policy database 122, in accordance with various embodiments of the present invention.

In step 204, data management program 200 identifies updated policy information. More specifically, in response to determining that a data policy update is available (decision step 202, YES branch), data management program 200 identifies updated policy information associated with the data policy update (step 204). In one embodiment, data management program 200 analyzes the new or updated data management policy utilizing NLP techniques, rule categorization, feature extraction etc., to identify information that updates information in data policy database 122. For example, data management program 200 can utilize NLP analysis to identify a change in a data management policy, relative to a version of the data management policy that exists in data policy database 122. In various embodiments, data management system 120 receives incoming data management policies for addition to data policy database 122 that are in a format that is readable utilizing analysis techniques of data management system 120 (e.g., NLP techniques).

In another embodiment, data management program 200 analyzes data management policies to identify and extract content descriptors (e.g., address, photograph, name, etc.) to compare information with data in data policy database to determine changes to data policies, with respect to policies in data policy database 122. In additional embodiments, data management program 200 can compare versions of data management policies to determine changes. For example, data management program 200 can compare a new version of a right to be forgotten policy to a version of a right to be forgotten policy that already exists in data policy database 122 to identify new sections and/or revisions to sections. In another example, data management program 200 correlates the new/received data policies to the existing policies in data policy database. Data management program 200 can then compare the correlated policies to determine which information has been changed and/or added.

In additional embodiments, data management program 200 can receive a data management policy for direct action on data records in enterprise database 122. For example, data management program 200 receives a new data management instruction to delete a specific set of data records. In another example, data management program 200 determines that an action has occurred (e.g., a case resolution, contract completion, etc.). In this example, data management program 200 can determine that a data management action is required, based on the determined action.

In an example scenario, data management program 200 utilizes NLP to analyze a right to be forgotten data policy (received by data management system 120). In this example scenario, data management program 200 determines that the right to be forgotten data policy includes an update regarding when to delete or anonymize data records, relative to the right to be forgotten data management policy in data policy database 122. Accordingly, data management program 200 identifies the update to the right to be forgotten data policy for utilization in managing data records in enterprise database 130.

In step 206, data management program 200 generates data management rules based on the updated policy information. In one embodiment, data management program 200 generates new, or updates existing, data management rules for an organization based on the identified updated data management policy information (in step 204). For example, data management program 200 generates new data management rules for data records in enterprise database 130, based on new policy requirements identified in step 204. A data management rule can include a defined action for data processing system 120 to take on data records (of enterprise database 130) that correspond to a defined characteristic, in accordance with various embodiments of the present invention. In additional embodiments, data management program 200 can generate new data management rules and integrate the new rules into an aggregated data management policy for an organization (e.g., stored in data policy database 122 and associated with enterprise database 130).

In a first example scenario, data management program 200 identifies information of a new right to be forgotten data management policy (in step 204). In this example scenario, the new policy information indicates for the organization to anonymize employee search history data after storage for 1 year. Data management program 200 can then generate a data management rule to anonymize data records with a timestamp greater than one year in enterprise database 130 that include employee search history data. Further, data management program 200 can store the generated new data management rule in data policy database 122 (e.g., as a component of an aggregated data management policy for the organization associated with enterprise database 130).

In a second example scenario, data management program 200 identifies information of an update to an existing right to be forgotten data management policy (in step 204). In this example scenario, the updated policy information indicates for the organization to delete a defined set of data records in enterprise database 130 after a defined event occurs (e.g., completion of a contract, resolution of a case, an employee leaving the organization, etc.). Data management program 200 can then generate a data management rule to delete the defined set of data records in response to determining that the defined event occurs. Further, data management program 200 can store the generated update of a data management rule in data policy database 122 (e.g., as a component of an aggregated data management policy for the organization associated with enterprise database 130).

In another embodiment, data management program 200 can determine and utilize a hierarchy of data management policies when generating rules to resolve potential conflicting and/or overlapping rule sets. For example, data management program 200 generates rules for an organization, while taking into account that a government regulation data management policy corresponds to a higher hierarchy than a data management policy that is an organizational preference.

In various embodiments, data management program 200 utilizes extracted features from the identified data policy updates to generate data management rules for data records associated with the extracted features. For example, data management program 200 can utilize features that include an age of a data record, a subject area of a data record, a type of a data record, and other identifiable features in accordance with embodiments of the present invention. In another embodiment, data management program 200 utilizes classifications of content and extracted content descriptors and tags from identified data policy updates to generate corresponding data management rules. For example, data management program 200 can utilize tags and descriptors that indicate specific data types (e.g., address, photographs, financial data, phone number, etc.) in data management rule generation, in accordance with various embodiments of the present invention.

In step 208, data management program 200 identifies data records that the generated rules impact. In one embodiment, data management program 200 searches enterprise database 130 to identify data records that the generated data management rules (from step 206) impact. In various embodiments, data management program 200 applies the rules generated in step 206, and other relevant rules from data policy database 122, with data in enterprise database 130. Based on the content of the applied rules, data management program 200 can identify data records to take action on immediately, and also identify data records to schedule for future action.

In additional embodiments, data management program 200 intersects the data in enterprise database 130 with the rules generated in step 206, and other relevant rules from data policy database 122, to identify data records, or portions of data records (e.g., parts of a document). In example embodiments, data management program 200 utilizes a beta distribution to determine a confidence of classifying whether content in data records is impacted by data management policies (i.e., classify records for action based on a confidence threshold according to a beta distribution). In a further embodiment, data management program 200 searches enterprise database 130 for data records that have corresponding tags that match tags indicated in data management rules. In another aspect, data management program 200 can communicate with a data backup system (e.g., data backup of enterprise database 130) to identify and request action on backup data that the generated data management rules impact.

In another embodiment, based on new/updated data management policies and rules, data management program 200 can schedule a query to execute on enterprise database 130 (e.g., every day, every week, etc.) to search for instances of any data records that correspond to a data management rule. In another aspect, a data management rule or policy, such as a right to be forgotten policy, can define a parameter that data management program 200 can utilize to determine a data search/query interval. For example, a policy defines that data must be deleted within seven days. In this example, data management program 200 can schedule to execute a query on enterprise database 130 every seven days (or less) to search for data records based on the rule and identify the data records for corresponding action.

In the previously discussed first example scenario, data management program 200 generates a data management rule to anonymize data records with a timestamp greater than one year in enterprise database 130 that include employee search history data (in step 206). In this example scenario, data management program 200 searches enterprise database 130 utilizing the rule, identifying data records that are currently impacted by the rule, and data records that the rule will impact in the future. In the previously discussed second example scenario, data management program 200 generates a data management rule to delete a defined set of data records in response to determining that a defined event occurs (in step 206). In this example scenario, data management program 200 searches enterprise database 130 utilizing the rule, identifying data records that are currently impacted by the rule, and data records that the rule will impact in the future.

In step 210, data management program 200 schedules future data management operations. In one embodiment, data management program 200 schedules future data management actions for data records in enterprise database 130 that a rule will impact in the future (i.e., to take action on corresponding to a rule at a future point in time). In various embodiments, data management program 200 schedules an action based on the action defined or required by the data management policy, such as delete, migrate, modify, anonymize, encrypt, modify access, etc.

For example, a data management rule defines to take action (e.g., delete, modify, move, etc.) on a category of data records when the data records are three years old. In this example, data management program 200 can identify timestamp data for data records in enterprise database 130 that correspond to the category and schedule the corresponding data management action for when the timestamp data indicates that the respective data records are three years old. In additional embodiments, data management program 200 can communicate with a data backup system (e.g., data backup of enterprise database 130) to schedule future actions on backup data that the generated data management rules impact.

In the previously discussed first example scenario, data management program 200 identifies data records (in step 208) that include employee search history and timestamp data corresponding to the data records. In this example scenario, data management program 200 schedules respective future data management actions (i.e., to anonymize) on data in the identified data records when a respective timestamp is greater than one year old.

In the previously discussed second example scenario, data management program 200 identifies data records (in step 208) in enterprise database 130 that correspond to the defined data set of records. In this example scenario, data management program 200 determines whether the defined event has occurred (e.g., completion of a contract, resolution of a case, an employee leaving the organization, etc.). In response to determining that the defined event has not yet occurred, data management program 200 can schedule a future data management action on the defined set of data records, for when the defined action occurs. In another embodiment, in response to determining that the defined event has not yet occurred, data management program 200 can schedule one or more future queries to check whether the defined event has occurred.

In step 212, data management program 200 performs current data management actions. In one embodiment, data management program 200 performs data management actions on data records in enterprise database 130 that a rule (e.g., a new rule from step 206) is currently impacting. In various embodiments, data management program 200 performs an action based on the action defined or required by the data management policy, such as delete, migrate, modify, anonymize, encrypt, modify access, etc.

For example, a data management rule defines to take action (e.g., delete, modify, move, etc.) on a category of data records when the data records are three years old. In this example, data management program 200 can identify timestamp data for data records in enterprise database 130 that correspond to the category and execute the corresponding data management action on data records with a respective timestamp that is over three years old. In additional embodiments, data management program 200 can communicate with a data backup system (e.g., data backup of enterprise database 130) to execute actions on backup data that the generated data management rules impact.

In the previously discussed first example scenario, data management program 200 identifies data records (in step 208) in enterprise database 130 that include employee search history and timestamp data corresponding to the data records. In this example scenario, data management program 200 anonymizes data records in enterprise database 130 that include employee search history and have a corresponding timestamp that is greater than one year old.

In the previously discussed second example scenario, data management program 200 identifies data records (in step 208) in enterprise database 130 that correspond to the defined data set of records. In this example scenario, data management program 200 determines whether the defined event has occurred (e.g., completion of a contract, resolution of a case, an employee leaving the organization, etc.). In response to determining that the defined event has occurred, data management program 200 executes a data management action to delete the defined set of records.

In step 214, data management program 200 sends notifications. In one embodiment, data management program 200 sends actions of performed and/or scheduled data management actions (of steps 210 and 212) to one or more associated users. In various embodiments, data management program 200 communicates notifications according to the corresponding data management policy that dictated the data management action. In an example embodiment, data management program 200 notifies a user of computing device 110, according to notification requirements and preferences in data policy database 122.

For example, a right to be forgotten data management policy can indicate one or more parties (with respect to a particular data record) that data management system 120 is required to notify upon completion of a corresponding data management action. Accordingly, data management program 200 sends a notification to the required parties upon completion of the data management action. In another aspect, data management program 200 can notify individuals of upcoming scheduled data management actions, per organization and policy preferences and/or policy requirements.

FIG. 3 depicts computer system 300, which is representative of computing device 110 and data management system 120, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made. Computer system 300 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to computing device 110, software and data 310 includes user interface 112 and application 114. With respect to data management system 120, software and data 310 include data policy database 122 and data management program 200.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
monitoring, by one or more processors, data sources for updates to data management policies that apply to an organization;
in response to identifying an update to a data management policy that applies to the organization, generating, by one or more processors, a data management rule based on the update to the data management policy, wherein the data management rule includes a defined action to take on data records that correspond to a defined characteristic;
identifying, by one or more processors, a first set of data records that include the defined characteristic of the data management rule; and
performing, by one or more processors, the defined action of the data management rule on the first set of data records.

2. The method of claim 1, wherein generating a data management rule based on the update to the data management policy further comprises:
determining, by one or more processors, differences between the identified update to the data management policy that applies to the organization and existing data management policies associated with the organization; and
generating, by one or more processors, the data management rule corresponding to the determined differences.

3. The method of claim 1, further comprising:
identifying, by one or more processors, a second set of data records that will include the defined characteristic of the data management rule at a future time, based on timestamp data of the second set of data records; and
scheduling, by one or more processors, execution of the defined action of the data management rule on the second set of data records at the future time, based on the timestamp data of the second set of data records.

4. The method of claim 1, wherein the data management policy is a right to be forgotten data management policy.

5. The method of claim 1, further comprising:
communicating, by one or more processors, results of performing the defined action to one or more users, based on specifications of the data management policy.

6. The method of claim 1, wherein identifying the first set of data records that include the defined characteristic of the data management rule further comprises:
searching, by one or more processors, a database associated with the organization for data records that include the defined characteristic of the data management rule.

7. The method of claim 1, wherein the defined action is an action selected from the group consisting of deleting a data record, migrating a data record, anonymizing a data record, modifying a data record, and modifying a portion of a data record.

8. A computer program product comprising:
one or more computer readable storage media and program instructions stored on the one or more computer readable storage media, the program instructions comprising:
program instructions to monitor data sources for updates to data management policies that apply to an organization;
in response to identifying an update to a data management policy that applies to the organization, program instructions to generate a data management rule based on the update to the data management policy, wherein the data management rule includes a defined action to take on data records that correspond to a defined characteristic;
program instructions to identify a first set of data records that include the defined characteristic of the data management rule; and
program instructions to perform the defined action of the data management rule on the first set of data records.

9. The computer program product of claim 8, wherein the program instructions to generate a data management rule based on the update to the data management policy further comprises program instructions to:
determine differences between the identified update to the data management policy that applies to the organization and existing data management policies associated with the organization; and
generate the data management rule corresponding to the determined differences.

10. The computer program product of claim 8, further comprising program instructions, stored on the one or more computer readable storage media, to:
identify a second set of data records that will include the defined characteristic of the data management rule at a future time, based on timestamp data of the second set of data records; and
schedule execution of the defined action of the data management rule on the second set of data records at the future time, based on the timestamp data of the second set of data records.

11. The computer program product of claim 8, wherein the data management policy is a right to be forgotten data management policy.

12. The computer program product of claim 8, further comprising program instructions, stored on the one or more computer readable storage media, to:
communicate results of performing the defined action to one or more users, based on specifications of the data management policy.

13. The computer program product of claim 8, wherein the program instructions to identify a first set of data records that include the defined characteristic of the data management rule further comprise program instructions to:
search a database associated with the organization for data records that include the defined characteristic of the data management rule.

14. A computer system comprising:
one or more computer processors;
one or more computer readable storage media; and
program instructions stored on the computer readable storage media for execution by at least one of the one or more processors, the program instructions comprising:
program instructions to program instructions to monitor data sources for updates to data management policies that apply to an organization;
in response to identifying an update to a data management policy that applies to the organization, program instructions to generate a data management rule based on the update to the data management policy, wherein the data management rule includes a defined action to take on data records that correspond to a defined characteristic;
program instructions to identify a first set of data records that include the defined characteristic of the data management rule; and
program instructions to perform the defined action of the data management rule on the first set of data records.

15. The computer system of claim 14, wherein the program instructions to generate a data management rule based on the update to the data management policy further comprises program instructions to:
determine differences between the identified update to the data management policy that applies to the organization and existing data management policies associated with the organization; and
generate the data management rule corresponding to the determined differences.

16. The computer system of claim 14, further comprising program instructions, stored on the computer readable storage media for execution by at least one of the one or more processors, to:
identify a second set of data records that will include the defined characteristic of the data management rule at a future time, based on timestamp data of the second set of data records; and
schedule execution of the defined action of the data management rule on the second set of data records at the future time, based on the timestamp data of the second set of data records.

17. The computer system of claim 15, wherein the data management policy is a right to be forgotten data management policy.

18. The computer system of claim 15, further comprising program instructions, stored on the computer readable storage media for execution by at least one of the one or more processors, to:
communicate results of performing the defined action to one or more users, based on specifications of the data management policy.

19. The computer system of claim 15, wherein the program instructions to identify a first set of data records that include the defined characteristic of the data management rule further comprise program instructions to:
search a database associated with the organization for data records that include the defined characteristic of the data management rule.

20. The computer system of claim 15, wherein the defined action is an action selected from the group consisting of deleting a data record, migrating a data record, anonymizing a data record, modifying a data record, and modifying a portion of a data record.
